(19) United States
(12) Patent Application Publication
(10) Pub. No.: US 2025/0119734 A1
(43) Pub. Date: Apr. 10, 2025

(54) Method for Device Security Gateway Function

(71) Applicant: T-Mobile Innovations LLC, Overland Park, KS (US)

(72) Inventors: Marouane BALMAKHTAR, Fairfax, VA (US); Lyle W. PACZKOWSKI, Mission Hills, KS (US)

(21) Appl. No.: 18/482,735

(22) Filed: Oct. 6, 2023

(51) Int. Cl. H04W 12/0471; H04W 12/0431; H04W 12/06

(52) U.S. Cl. CPC H04W 12/0471; H04W 12/0431; H04W 12/06

(57) ABSTRACT

A method for providing, in a computer connected via a network to a 5G core network, a security gateway function is provided. The method includes connecting the security gateway function to the 5G core network via a non-3GPP access network, registering the security gateway function with the non-3GPP access network, establishing a secure tunnel between the security gateway function and the 5G core network, obtaining authentication keys and security association keys for the security gateway function from the 5G core network, and establishing user plane and control plane connectivity between the security gateway function and the 5G core network. The security gateway function is configured to establish a secure connection to an external device coupled to the computer.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A 5^{th} Generation (5G) core network allows untrusted non-3rd Generation Partnership Project (non-3GPP) access and trusted non-3GPP access to the 5G core network. Untrusted non-3GPP access is provided to access points that are not maintained and operated by the operator of 5G core network (e.g., public hotspots, home Wi-Fi, and corporate Wi-Fi). Trusted non-3GPP access is provided to access points that the operator of 5G core network maintains and operates. Access for all untrusted non-3GPP access points is provided via the Non-3GPP Interworking Network Function, a part of the 5G core network that is provided at a centralized location within the 5G core network.

### SUMMARY

In an embodiment, a method for providing, in a computer connected via a network to a 5G core network, a security gateway function for an external device coupled to the computer is disclosed. The method comprises receiving, from a user of the computer, security rules for communication with the external device; storing the security rules in the security gateway function; establishing a secure connection to the external device based on the security rules stored in the security gateway function; connecting the security gateway function to the 5G core network via a non-3GPP access network; registering the security gateway function with the non-3GPP access network; establishing a secure tunnel between the security gateway function and the 5G core network; obtaining authentication keys and security association keys for the security gateway function from the 5G core network; establishing user plane and control plane connectivity between the security gateway function and the 5G core network; and exchanging one of control plane communications and user plane communications between the external device and the 5G core network.

In another embodiment, method for providing, in a computer connected via a network to a 5G core network, a security gateway function is disclosed. The method comprises connecting the security gateway function to the 5G core network via a non-3GPP access network; registering the security gateway function with the non-3GPP access network; establishing a secure tunnel between the security gateway function and the 5G core network; obtaining authentication keys and security association keys for the security gateway function from the 5G core network; and establishing user plane and control plane connectivity between the security gateway function and the 5G core network. The security gateway function is configured to establish a secure connection to an external device coupled to the computer.

In yet another embodiment, method for providing, in a computer connected via a network to a 5G core network, secure communication with the 5G core network for an external device coupled to the computer is disclosed. The method comprises establishing a secure connection to the external device; receiving, from the external device, a request for connection to the 5G core network, the request comprising information specifying one of (i) a first connection via a Non-3GPP Interworking Function of the 5G core network and (ii) a second connection to the 5G core network via a security gateway function of the computer; determining whether the information specifies the first connection or the second connection. The method further comprises in response to determining that the information specifies the first connection, establishing a connection between the external device and the Non-3GPP Interworking Network Function of the 5G core network. The method further comprises in response to determining that the information specifies the second connection, connecting the security gateway function to the 5G core network via a non-3GPP access network; registering the security gateway function with the non-3GPP access network; establishing a secure tunnel between the security gateway function and the 5G core network; obtaining authentication keys and security association keys for the security gateway function from the 5G core network; establishing user plane and control plane connectivity between the security gateway function and the 5G Core network; and exchanging one of control plane communications and user plane communications between the external device and the 5G core network.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a first communication system according to an embodiment of the disclosure.

FIG. 2 is a block diagram of a second communication system according to an embodiment of the disclosure.

FIG. 3 is a flow chart of a first method according to an embodiment of the disclosure.

FIG. 4 is a flow chart of a second method according to an embodiment of the disclosure.

FIG. 5 is a flow chart of a third method according to an embodiment of the disclosure.

FIG. 6 is a block diagram of a hardware architecture of a device according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

It is expected that, in the near future an increasing number of non-3GPP devices may be served by a 5G core network. If supported using the conventional Non-3GPP Interworking Network Function disposed at a centralized location, this increase in non-3GPP devices being served will create problems for the 5G core network. Methods according to the disclosure provide 5G core network connectivity to non-3GPP devices via decentralized devices, such as smart phones or other user equipment (UE), reducing the processing load on a centralized Non-3GPP Interworking Network Function of the 5G core network. Methods according to the disclosure may be referred to as providing a security gateway function. Such a security gateway function mediates secure access of Non-3GPP devices to the 5G core network. More specifically, such a security gateway function provides (a) authentication/authorization functions and (b) secure tunnel termination. Such a security gateway function may provide other functions as well, such as policy enforcement, network slicing, and Quality of Service (QoS) enforcement.

A security gateway function according to the disclosure may be configured as a lightweight function that executes in a computing environment different than functions operating in the 5G core network, for example, a computing environment having fewer processing resources available or different local security services. Such a security gateway function may be adapted to local applications, security requirements, or existing local data networks.

Some of the benefits provided by methods according to the disclosure are increased flexibility and compartmentalization. In a first example, Radio Frequency Identification (RFID) readers in a warehouse that read the presence of containers, pallets, or products are connected by a local network to a WiFi router, which sends the readers' information securely to servers on the 5G core network via a security gateway function according to the disclosure. In various methods according to the disclosure, the data network or WiFi router may implement network security that is appropriate to its local network, and then rely on the security gateway function to provide a secure connection with the 5G core network.

In a second example, an enterprise might wish to connect a large number of non-3GPP devices to a data network that it maintains and, further, to mediate access of this data network to the 5G core network using the security gateway function. In various embodiments, a security gateway function according to the disclosure may obtain from the 5G core network, for the non-3GPP devices of the data network, services such as authentication, policy control, network slicing, QoS flow, key management, and/or subscription data retrieval.

In a third example, an enterprise data network may include both legacy non-3GPP elements that, as implemented, connect to the 5G core network via the Non-3GPP Interworking Network Function of the 5G core network, as well as more recently developed non-3GPP elements implemented to connect to the 5G core network via the security gateway function. A security gateway function according to the disclosure for such a data network may allow network devices to request a connection to the 5G core network via either the Non-3GPP Interworking Network Function of the 5G core network or the security gateway function, as appropriate.

In methods according to the disclosure, the security gateway function is an access point that an operator of the 5G core network maintains and operates. As such, the security gateway function connects to the 5G core network via trusted non-3GPP access, then acts as a gateway to provide distributed non-3GPP access to the devices that are coupled to the data network or WiFi router.

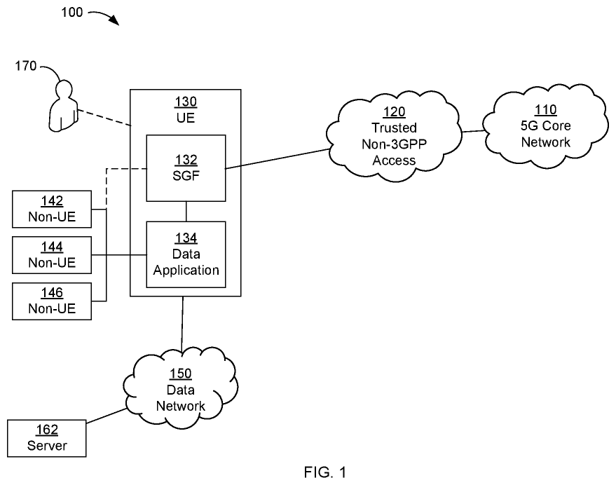

Turning now to FIG. 1, a communication system 100 according to the disclosure is described. In an embodiment, the system 100 comprises a 5G core network 110, a trusted non-3GPP access network 120, a UE 130, non-UE devices 142, 144 and 146, a data network 150, a server 162, and a user 170 of the UE 130. The UE 130 includes a security gateway function 132 and a data application 134. The security gateway function 132 is coupled to the trusted non-3GPP access network 120 and the data network 150. The data application is coupled to the security gateway function 132, the non-UE devices 142, 144 and 146 and the data network 150. The server 162 is also coupled to the data network 150.

The security gateway function 132 connects to the 5G core network 110 by performing network registration with the trusted non-3GPP access network 120. The security gateway function 132 establishes a secure tunnel with the 5G core network 110 to provide confidentiality and integrity for message traffic exchanged between the security gateway function 132 and the 5G core network 110. The security gateway function 132 enters into authentication and security association procedures with the 5G core network 110, to obtain mutual authentication and key establishment, in order to secure communication between the security gateway function 132 and the 5G core network 110. Once the authentication and security association are established, the security gateway function 132 establishes user plane connectivity with the 5G core network 110 to allow user data and signaling to be exchanged between the security gateway function 132 and the 5G core network 110.

The security gateway function 132 may obtain services from the 5G core network 110, as needed by the data application 134 and/or the UE 130. Examples of such services obtained may include requesting network resources, accessing subscriber data, initiating or receiving voice/video calls, and accessing data services. Other examples include authentication/authorization functions and secure tunnel termination, policy enforcement, network slicing, and QoS enforcement.

The security gateway function 132 exchanges data with the 5G core network 110 using the established user plane connectivity. Examples of such data that may be exchanged includes transmitting and receiving data packets for the data application 134 and/or the non-UE devices 142, 144 and 146, accessing cloud services via the 5G core network 110, and browsing the internet via the 5G core network 110.

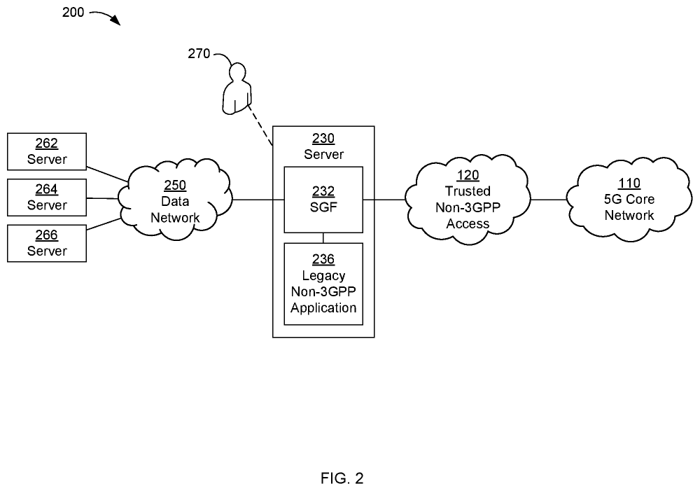

The security gateway function 132 is coupled to the data network 150 and thereby to the server 162. As discussed below with reference to FIG. 2, the data network 150 may include 3GPP and/or non-3GPP elements. The server 162 and/or the applications it executes may include 3GPP and/or non-3GPP functions. In various embodiments, the security gateway function 132 provides pass-through connectivity to the 5G core network 110 via the trusted non-3GPP access network 120 for non-3GPP and/or mediated connectivity for non-3GPP elements and functions to the 5G core network 110 via the trusted non-3GPP access network 120.

The data application 134 is coupled to the non-UE devices 142, 144 and 146 by a non-3GPP communication link such as Wi-Fi, WiMAX, CDMA, RFID, or other wired or wireless protocol not specified in the 3GPP standard. In some cases, the data application 134 sends individual data received from the non-UE devices 142, 144 and 146 to servers in the 5G core network 100 via the security gateway function 132. In other cases, the data application 134 processes a plurality of such received data before sending the result to a destination in the 5G core network 100 via the security gateway function 132.

In a first example, the non-UE devices 142, 144 and 146 may be RFID readers that receive data from multiple RFID tags and transfer the data to the data application 134, which may consolidate the data before sending the data to servers in the 5G core network 100 via the security gateway function 132. In a second example, the non-UE devices 142, 144 and 146 may be Internet of Things (IoT) devices that couple directly to the security gateway function 132. The security gateway function 132 provides a remote communication function to enable multiple IoT devices to have individual identities within the 5G core network 100. Such individual identities would significantly increase network traffic and 5G core network processing burden if provided via the Non-3GPP Interworking Network Function.

FIG. 2 is a block diagram of a second communication system 200 according to an embodiment of the disclosure. In an embodiment, the system 200 comprises a 5G core network 110, a trusted non-3GPP access network 120, and a server 230. The server 230 includes a security gateway function 232 and a legacy non-3GPP application 236. A user 270 of the server 230 may execute functions of the server 230, the security gateway function 232, the legacy non-3GPP application 236, and/or legacy non-3GPP applications of the server 230. The security gateway function 232 is coupled to the trusted non-3GPP access network 120 and the data network 250. The legacy non-3GPP application 236 is coupled to the security gateway function 232.

In some embodiments, the system 200 further includes servers 262, 264, and 266 coupled to the server 230 via a data network 250. The servers 262, 264, and 266 may include 3GPP and/or non-3GPP applications or functions. In various embodiments, the security gateway function 232 provides pass-through connectivity to the 5G core network 110 via the trusted non-3GPP access network 120 for non-3GPP applications and functions of the servers 262, 264, and 266 and the server 230 and/or mediated connectivity for non-3GPP elements and functions of the servers 262, 264, and 266. In some embodiments, the security gateway function 232 provides access to the 5G core network 110 via the Non-3GPP Interworking Network Function of the 5G core network 110, when requested by the legacy non-3GPP application 236.

The security gateway function 232 connects to the 5G core network 110 by performing network registration with the trusted non-3GPP access network 120. The security gateway function 232 establishes a secure tunnel with the 5G core network 110 to provide confidentiality and integrity for message traffic exchanged between the security gateway function 232 and the 5G core network 110. The security gateway function 232 enters into authentication and security association procedures with the 5G core network 110, to obtain mutual authentication and key establishment, in order to secure communication between the security gateway function 232 and the 5G core network 110. Once the authentication and security association are established, the security gateway function 232 establishes user plane connectivity with the 5G core network 110 to allow user data and signaling to be exchanged between the security gateway function 232 and the 5G core network 110.

The security gateway function 232 may obtain services from the 5G core network 110, as needed by the non-3GPP applications and functions of the servers 262, 264, and 266 and the server 230. Examples of such services obtained may include requesting network resources, accessing subscriber data, initiating or receiving voice/video calls, and accessing data services. Other examples include authentication/authorization functions and secure tunnel termination, policy enforcement, network slicing, and QoS enforcement.

The security gateway function 232 exchanges data with the 5G core network 110 using the established user plane connectivity. Examples of such data that may be exchanged includes transmitting and receiving data packets for the servers 262, 264, and 266 and the server 230, accessing cloud services via the 5G core network 110, and browsing the internet via the 5G core network 110.

The trusted non-3GPP access network 120 may include two configurations. In a first configuration, the security gateway function 132 (or, in the following discussion, the security gateway function 232) couples to the trusted non-3GPP access network 120 via a Trusted Non-3GPP Access Point Function (TNAP) and a Trusted Non-3GPP Gateway Function (TNGF). In a second configuration, the security gateway function 132 couples to the non-3GPP access network 120 via a Trusted WLAN Access Network (TWAP) and a Trusted WLAN Interworking Function (TWIF). In some embodiments, the security gateway function 132 is configured to support connection to the trusted non-3GPP access network 120 in both the first and second configurations. In other embodiments, the security gateway function 132 is configured to support connection to the trusted non-3GPP access network 120 in only one or the other of the first and second configurations. In still other embodiments, the security gateway function 132 is configured to support 5G Non-Access Stratum signaling between the 5G core network 110 and non-3GPP applications and functions coupled to the security gateway function 132.

Functions described herein as performed by individual ones of the server computers of the communication system 100 may be performed by other servers. A single server may perform multiple functions. Not all of the servers of system 100 may be used in some embodiments of the disclosure.

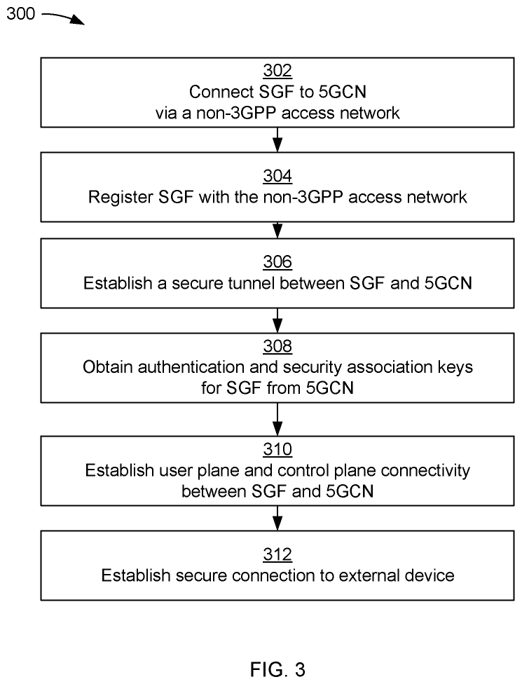

FIG. 3 is a flow chart of a first method 300 according to an embodiment of the disclosure for providing the security gateway function 132 in the UE 130. In step 302, the security gateway function 132 connects to the 5G core network 110 via the trusted non-3GPP access network 120. In step 304, the security gateway function 132 registers with the trusted non-3GPP access network 120. In step 306, the security gateway function 132 establishes a secure tunnel between the security gateway function 132 and the 5G core network 110. In step 308, the security gateway function 132 obtains authentication keys and security association keys from the 5G core network 110. In step 310, the security gateway function 132 establishes user plane and control plane connectivity between the security gateway function 132 and the 5G core network 110. In step 312, the security gateway function 132 establishes a secure connection to an external device (e.g., the non-UE 142 or the server 162) that is coupled to the UE 130.

In some embodiments of the method 300, the security gateway function 132 further provides from the 5G core network to the external device one of an authentication function, a policy control function, a network slicing configuration, a Quality of Service flow, a key management function, and a subscription data retrieval. In other embodiments of the method 300, the security gateway function 132 is configured to determine whether the external device has previously been coupled to the UE 130. If so, once the secure connection to the external device has been re-established, the security gateway function 132 provides to the external device information that is stored in the security gateway function 132. Such information relates to one or more of the authentication function, the policy control function, the network slicing configuration, the Quality of Service flow, the key management function, and the subscription data provided from the security gateway function 132 to the external device.

In some embodiments of the method 300, the security gateway function 132 obtains authentication keys and security association keys from the 5G core network 110 using one of a 5G Authentication and Key Agreement (5G-AKA), an Extensible Authentication Protocol (EAP) AKA variant (EAP-AKA′), and an EAP Transport Layer Security (EAP-TLS) protocol. In some embodiments of the method 300, the security gateway function 132 is configured to exchange control plane communications and/or user plane communications between the external device and the 5G core network 110. In other embodiments of the method 300, the security gateway function 132 exchanges control plane communications and/or user plane communications between the 5G core network 110 and the data application 134 or other applications executing on the UE 130, the non-UEs 142, 144, and 146, or the server 162.

In some embodiments of the method 300, the security gateway function 132 provides other communication with the 5G core network 110 for a plurality of external devices (e.g., the non-UEs 142, 144, and 146). In some such embodiments of the method 300, the plurality of external devices comprise sensors.

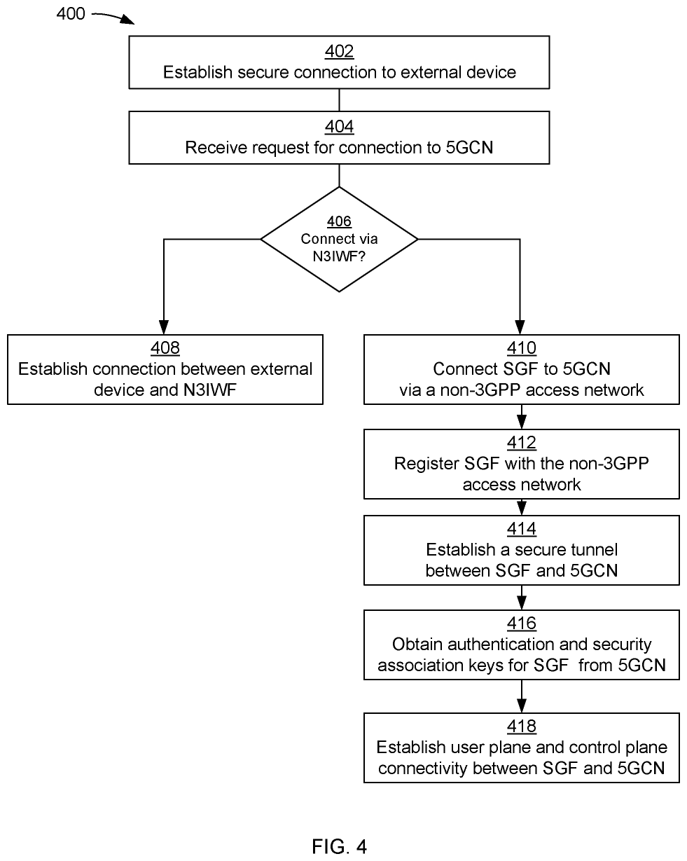

FIG. 4 is a flow chart of a second method 400 according to an embodiment of the disclosure for providing the security gateway function 132 in the UE 130 or the security gateway function 232 in the server 230. In step 402, the security gateway function 132 or 232 establishes a secure connection to an external device. In one example, the external device is the server 162. In another example, the external device is one of the servers 262, 264, or 266.

In step 404, the security gateway function 132 or 232 receives, from the external device, a request for connection to the 5G core network 110. The request includes information specifying (i) a connection via a Non-3GPP Interworking Function of the 5G core network 110 or (ii) a connection to the 5G core network 110 via the security gateway function 132 or 232. In step 406, the security gateway function 132 or 232 determines whether the information specifies a connection via the Non-3GPP Interworking Network Function of the 5G core network 110. If so, in step 408, the security gateway function 132 or 232 establishes a connection between the external device and the Non-3GPP Interworking Network Function using a conventional non-3GPP protocol.

If, in step 406, the security gateway function 132 or 232 determines that the external device has requested a connection to the 5G core network via the security gateway function 132 or 232, in step 410 the security gateway function 132 or 232 connects to the 5G core network 110 via the trusted non-3GPP access network 120. In step 412, the security gateway function 132 or 232 registers with the trusted non-3GPP access network 120. In step 414, the security gateway function 132 or 232 establishes a secure tunnel between the security gateway function 132 or 232 and the 5G core network 110. In step 416, the security gateway function 132 or 232 obtains authentication keys and security association keys from the 5G core network 110. In step 418, the security gateway function 132 or 232 establishes user plane and control plane connectivity between the security gateway function 132 or 232 and the 5G core network 110.

In some embodiments of the method 400 where the external device has requested a connection to the 5G core network via the security gateway function 132 or 232, the security gateway function 132 or 232 further provides from the 5G core network to the external device one of an authentication function, a policy control function, a network slicing configuration, a Quality of Service flow, a key management function, and a subscription data retrieval. In other embodiments of the method 400 where the external device has requested a connection to the 5G core network via the security gateway function 132 or 232, the security gateway function 132 or 232 is configured to determine whether the external device has previously been coupled to the UE 130 or the server 230. If so, once the secure connection to the external device has been re-established, the security gateway function 132 or 232 provides to the external device information that is stored in the security gateway function 132 or 232. Such information relates to one or more of the authentication function, the policy control function, the network slicing configuration, the Quality of Service flow, the key management function, and the subscription data provided from the security gateway function 132 or 232 to the external device.

In some embodiments of the method 400 where the external device has requested a connection to the 5G core network via the security gateway function 132 or 232, the security gateway function 132 or 232 exchanges control plane communications and/or user plane communications between the external device and the 5G core network 110. In other embodiments of the method 400 where the external device has requested a connection to the 5G core network via the security gateway function 132 or 232, the security gateway function 132 or 232 obtains authentication keys and security association keys from the 5G core network 110 using one of a 5G Authentication and Key Agreement (5G-AKA), an Extensible Authentication Protocol (EAP) AKA variant (EAP-AKA′), and an EAP Transport Layer Security (EAP-TLS) protocol.

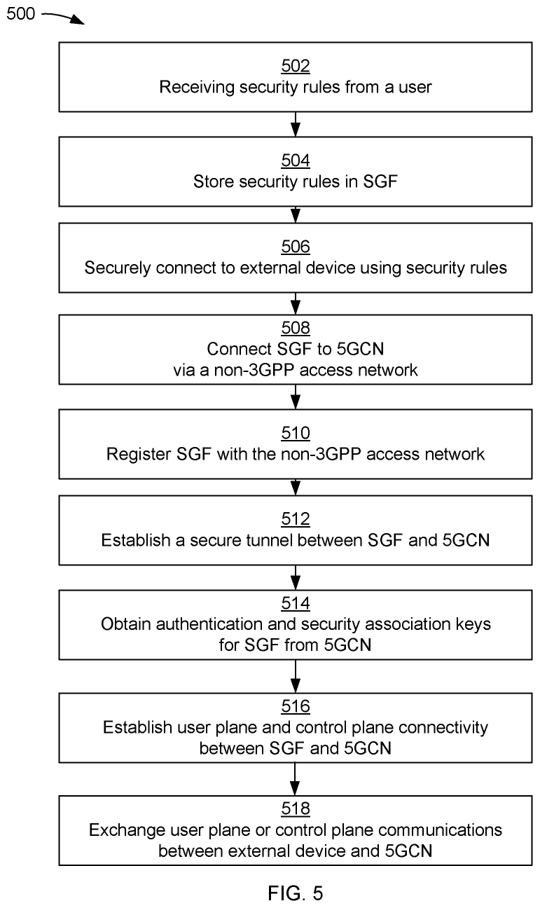

FIG. 5 is a flow chart of a third method 500 according to an embodiment of the disclosure for providing the security gateway function 132 in the UE 130 or the security gateway function 232 in the server 230. In step 502, the security gateway function 132 or 232 receives from a user of the UE 130 or the or the server 230 security rules for communication with an external device, which are stored in the security gateway function 132 or 232 in step 504. In one example, the external device is the server 162. In another example, the external device is one of the servers 262, 264, or 266. In step 506, the security gateway function 132 or 232 establishes a secure connection to the external device based on the stored security rules.

In step 508, the security gateway function 132 or 232 connects to the 5G core network 110 via the trusted non-3GPP access network 120. In step 510, the security gateway function 132 or 232 registers with the trusted non-3GPP access network 120. In step 512, the security gateway function 132 or 232 establishes a secure tunnel between the security gateway function 132 or 232 and the 5G core network 110. In step 514, the security gateway function 132 or 232 obtains authentication keys and security association keys from the 5G core network 110. In step 516, the security gateway function 132 or 232 establishes user plane and control plane connectivity between the security gateway function 132 or 232 and the 5G core network 110. In step 518, the security gateway function 132 or 232 exchanges control plane communications or user plane communications between the external device and the 5G core network 100.

In some embodiments of the method 500, the security gateway function 132 or 232 further provides from the 5G core network to the external device one of an authentication function, a policy control function, a network slicing configuration, a Quality of Service flow, a key management function, and a subscription data retrieval. In other embodiments of the method 500, the security gateway function 132 or 232 is configured to determine whether the external device has previously been coupled to the UE 130 or the server 230. If so, once the secure connection to the external device has been re-established, the security gateway function 132 or 232 provides to the external device information that is stored in the security gateway function 132 or 232. Such information relates to one or more of the authentication function, the policy control function, the network slicing configuration, the Quality of Service flow, the key management function, and the subscription data provided from the security gateway function 132 or 232 to the external device.

In some embodiments of the method 500, the security gateway function 132 or 232 obtains authentication keys and security association keys from the 5G core network 110 using one of a 5G Authentication and Key Agreement (5G-AKA), an Extensible Authentication Protocol (EAP) AKA variant (EAP-AKA′), and an EAP Transport Layer Security (EAP-TLS) protocol. In other embodiments of the method 500, the security gateway function 132 or 232 exchanges control plane communications and/or user plane communications between the external device and the 5G core network 110.

In some embodiments of the method 500, the security gateway function 132 provides other communication with the 5G core network 110 for a plurality of external devices (e.g., the non-UEs 142, 144, and 146). In some such embodiments of the method 500, the plurality of external devices comprise sensors.

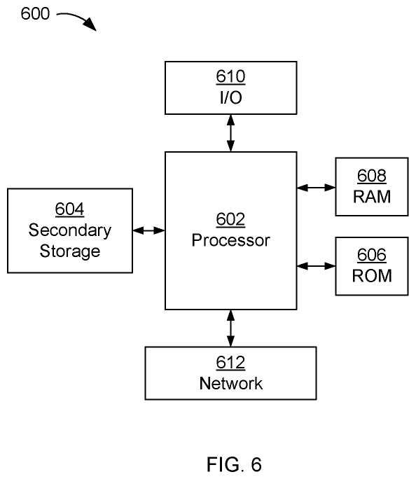

FIG. 6 is a block diagram of a hardware architecture of a server computer 600 according to an embodiment of the disclosure. The server computer 600 may be suitable for implementing methods 300, 400 or 500. The server computer 600 includes a processor 602 (which may be referred to as a central processor unit or CPU) that is in communication with memory devices including secondary storage 604, ROM 606, and RAM 608. The processor 602 is also in communication with input/output (I/O) devices 610, and network connectivity devices 612. The processor 602 may be implemented as one or more CPU chips.

It is understood that by programming and/or loading executable instructions onto the server computer 600, at least one of the CPU 602, the RAM 608, and the ROM 606 are changed, transforming the server computer 600 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 600 is turned on or booted, the CPU 602 may execute a computer program or application. For example, the CPU 602 may execute software or firmware stored in the ROM 606 or stored in the RAM 608. In some cases, on boot and/or when the application is initiated, the CPU 602 may copy the application or portions of the application from the secondary storage 604 to the RAM 608 or to memory space within the CPU 602 itself, and the CPU 602 may then execute instructions that the application is comprised of. During execution, an application may load instructions into the CPU 602, for example load some of the instructions of the application into a cache of the CPU 602. In some contexts, an application that is executed may be said to configure the CPU 602 to do something, e.g., to configure the CPU 602 to perform the function or functions promoted by the subject application. When the CPU 602 is configured in this way by the application, the CPU 602 becomes a specific purpose computer or a specific purpose machine.

The secondary storage 604 is used for non-volatile storage of data and as an over-flow data storage device if RAM 608 is not large enough to hold all working data. Secondary storage 604 may be used to store programs which are loaded into RAM 608 when such programs are selected for execution. The ROM 606 is used to store instructions and perhaps data which are read during program execution. ROM 606 is a non-volatile memory device which typically has a small memory capacity relative to the larger memory capacity of secondary storage 604. The RAM 608 is used to store volatile data and perhaps to store instructions. Access to both ROM 606 and RAM 608 may be faster than to secondary storage 604. The secondary storage 604, the RAM 608, and/or the ROM 606 may be referred to in some contexts as computer readable storage media and/or non-transitory computer readable media.

The processor 602 executes instructions, codes, computer programs, scripts which it accesses from the secondary storage 604, the ROM 606, or the RAM 608. While only one processor 602 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 604, the ROM 606, and/or the RAM 608 may be referred to in some contexts as non-transitory instructions and/or non-transitory information.

In some contexts, the secondary storage 604, the ROM 606, and the RAM 608 may be referred to as a non-transitory computer readable medium or a computer readable storage media. A dynamic RAM embodiment of the RAM 608, likewise, may be referred to as a non-transitory computer readable medium in that while the dynamic RAM receives electrical power and is operated in accordance with its design, for example during a period of time during which the server computer 600 is powered up and operational, the dynamic RAM stores information that is written to it. Similarly, the processor 602 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for providing, in a computer connected via a network to a 5G core network, a security gateway function for an external device coupled to the computer, the method comprising:
receiving, from a user of the computer, security rules for communication with the external device;
storing the security rules in the security gateway function;
establishing a secure connection to the external device based on the security rules stored in the security gateway function;
connecting the security gateway function to the 5G core network via a non-3GPP access network;
registering the security gateway function with the non-3GPP access network;
establishing a secure tunnel between the security gateway function and the 5G core network;
obtaining authentication keys and security association keys for the security gateway function from the 5G core network;
establishing user plane and control plane connectivity between the security gateway function and the 5G core network; and
exchanging one of control plane communications and user plane communications between the external device and the 5G core network.

2. The method of claim 1, wherein the security gateway function is further configured to provide from the 5G core network to the external device one of an authentication function, a policy control function, a network slicing configuration, a Quality of Service flow, a key management function, and a subscription data retrieval.

3. The method of claim 2, wherein the security gateway function is further configured to, where the external device has previously been coupled to the computer and once the secure connection to the external device has been re-established:
provide information stored in the security gateway function to the external device, the information relating to one or more of the authentication function, the policy control function, the network slicing configuration, the Quality of Service flow, the key management function, and the subscription data.

4. The method of claim 1, wherein obtaining keys and security association keys for the security gateway function from the 5G core network comprises using one of a 5G Authentication and Key Agreement (5G-AKA), an Extensible Authentication Protocol (EAP) AKA variant (EAP-AKA′), and an EAP Transport Layer Security (EAP-TLS) protocol.

5. The method of claim 1, wherein the security gateway function is further configured to exchange one of control plane communications and user plane communications between an application executing on the computer and the 5G core network.

6. The method of claim 5, wherein the external device is a first external device and the application is configured to communicate with a plurality of second external devices.

7. The method of claim 6, wherein the second external devices of the plurality of second external devices comprise sensors.

8. A method for providing, in a computer connected via a network to a 5G core network, a security gateway function, the method comprising:
connecting the security gateway function to the 5G core network via a non-3GPP access network;
registering the security gateway function with the non-3GPP access network;
establishing a secure tunnel between the security gateway function and the 5G core network;
obtaining authentication keys and security association keys for the security gateway function from the 5G core network; and
establishing user plane and control plane connectivity between the security gateway function and the 5G core network,
wherein the security gateway function is configured to establish a secure connection to an external device coupled to the computer.

9. The method of claim 8, wherein the security gateway function is further configured to provide from the 5G core network to the external device one of an authentication function, a policy control function, a network slicing configuration, a Quality of Service flow, a key management function, and a subscription data retrieval.

10. The method of claim 9, wherein the security gateway function is further configured to, where the external device has previously been coupled to the computer and once the secure connection to the external device has been re-established:
provide information stored in the security gateway function to the external device, the information relating to one or more of the authentication function, the policy control function, the network slicing configuration, the Quality of Service flow, the key management function, and the subscription data.

11. The method of claim 8, wherein obtaining authentication keys and security association keys for the security gateway function from the 5G core network comprises using one of a 5G Authentication and Key Agreement (5G-AKA), an Extensible Authentication Protocol (EAP) AKA variant (EAP-AKA′), and an EAP Transport Layer Security (EAP-TLS) protocol.

12. The method of claim 8, wherein the security gateway function is further configured to exchange one of control plane communications and user plane communications between the external device and the 5G core network.

13. The method of claim 8, wherein the security gateway function is further configured to exchange one of control plane communications and user plane communications between an application executing on the computer and the 5G core network.

14. The method of claim 13, wherein the security gateway function is configured to couple to the trusted non-3GPP access network via at least one of (i) a Trusted Non-3GPP Access Point Function (TNAP) and a Trusted Non-3GPP Gateway Function and (ii) a Trusted WLAN Access Network (TWAP) and a Trusted WLAN Interworking Function (TWIF).

15. The method of claim 8, wherein the security gateway function is configured to support 5G Non-Access Stratum signaling between the 5G core network and the external device.

16. A method for providing, in a computer connected via a network to a 5G core network, secure communication with the 5G core network for an external device coupled to the computer, the method comprising:
establishing a secure connection to the external device;
receiving, from the external device, a request for connection to the 5G core network, the request comprising information specifying one of (i) a first connection via a Non-3GPP Interworking Function of the 5G core network and (ii) a second connection to the 5G core network via a security gateway function of the computer;
determining whether the information specifies the first connection or the second connection;
in response to determining that the information specifies the first connection, establishing a connection between the external device and the Non-3GPP Interworking Network Function of the 5G core network; and
in response to determining that the information specifies the second connection:
connecting the security gateway function to the 5G core network via a non-3GPP access network;
registering the security gateway function with the non-3GPP access network;
establishing a secure tunnel between the security gateway function and the 5G core network;
obtaining authentication keys and security association keys for the security gateway function from the 5G core network;
establishing user plane and control plane connectivity between the security gateway function and the 5G Core network; and
exchanging one of control plane communications and user plane communications between the external device and the 5G core network.

17. The method of claim 16, further comprising, in further response to determining that the information specifies the second connection, providing from the 5G core network to the external device one of an authentication function, a policy control function, a network slicing configuration, a Quality of Service flow, a key management function, and a subscription data retrieval.

18. The method of claim 17, further comprising, in further response to determining that the information specifies the second connection:
where the external device has previously been coupled to the computer and once the secure connection to the external device has been re-established, providing information stored in the security gateway function to the external device, the information relating to one or more of the authentication function, the policy control function, the network slicing configuration, the Quality of Service flow, the key management function, and the subscription data.

19. The method of claim 16, further comprising, in further response to determining that the information specifies the second connection, exchanging one of control plane communications and user plane communications between the external device and the 5G core network.

20. The method of claim 16, further comprising, in further response to determining that the information specifies the second connection, obtaining authentication keys and security association keys for the security gateway function from the 5G core network by using one of a 5G Authentication and Key Agreement (5G-AKA), an Extensible Authentication Protocol (EAP) AKA variant (EAP-AKA′), and an EAP Transport Layer Security (EAP-TLS) protocol.
